(19) United States
(12) Patent Application Publication
(10) Pub. No.: US 2024/0367509 A1
(43) Pub. Date: Nov. 7, 2024

(54) FINAL STAGE GEAR WHEEL ASSEMBLY

(71) Applicant: Punch Powertrain E-Vehicles N.V., Sint-Truiden (BE)

(72) Inventor: Jan Willem Van Der Vecht, Sint-Truiden (BE)

(73) Assignee: Punch Powertrain E-Vehicles N.V., Sint-Truiden (BE)

(21) Appl. No.: 18/687,010

(22) PCT Filed: Aug. 29, 2022
(86) PCT No.: PCT/EP2022/073944

§ 371 Date: Feb. 27, 2024

(30) Foreign Application Priority Data
Aug. 27, 2021 (NL) 2029077

(51) Int. Cl. B60K 17/04; B60K 1/02; F16H 57/00

(52) U.S. Cl. CPC B60K 17/043; B60K 1/02; F16H 57/0037

(57) ABSTRACT

A gear wheel assembly, in particular a final stage gear wheel assembly for a transmission system for a dual drive vehicle drive train includes first and second gear wheel arranged coaxially with respect to a first axis. The first gear wheel is adjacent to the second gear wheel and is coupled to the second gear wheel through an intermediate bearing that allows for relative rotation of the first gear wheel with respect to the second gear wheel around the first axis. The intermediate bearing arrangement comprises a first intermediate bearing. The first gear wheel is radially supported through the first intermediate bearing by the second gear wheel and the second gear wheel is radially supported through the first intermediate bearing by the first gear wheel.

The patent disclosure relates to a gear wheel assembly, in particular a final stage gear wheel assembly, for a transmission system for a dual drive vehicle drive train, a transmission system for a dual drive vehicle drive train comprising a gear wheel assembly, a dual drive vehicle drive train comprising the transmission system and a vehicle comprising at least one of the dual drive vehicle drive train.

In modern vehicles, in particular electric vehicles, an increasingly popular type of drive train comprises two motors per axle, such that each wheel can be directly driven by its own motor. This allows, for instance, for torque vectoring and for discarding of the differential. A challenge, however, is to provide such a drive train in a cost effective manner that can be efficiently be integrated into the vehicle.

It is an object, among other objects, of the present patent disclosure to provide for a gear wheel assembly, in particular a final stage gear wheel assembly, for a transmission system for a dual drive vehicle drive train that is more compact and cost-effective, such that it at least partially alleviates at least one of the above mentioned problems.

According to a first aspect, there is provided a gear wheel assembly, in particular a final stage gear wheel assembly of a parallel axis gear system, for a transmission system for a dual drive vehicle drive train, comprising:
a first gear wheel and a second gear wheel, wherein said first and second gear wheel are arranged coaxially with respect to a first axis, wherein said first gear wheel is arranged adjacent to said second gear wheel and is coupled to said second gear wheel through an intermediate bearing arrangement that allows for relative rotation of the first gear wheel with respect to the second gear wheel around said first axis;
wherein the intermediate bearing arrangement comprises a first intermediate bearing; and
wherein said first gear wheel is radially supported through the first intermediate bearing by said second gear wheel and wherein said second gear wheel is radially supported through the first intermediate bearing by said first gear wheel.

The gear wheel assembly is also referred to as a dual gear wheel assembly in case it comprises only two coaxially arranged gear wheels as described above. The present patent disclosure is, however, not limited to a gear wheel assembly comprising two coaxially arranged gear wheels, but can also comprise more than two gear wheels. In particular, the first gear wheel is at least radially supported, through the intermediate bearing, by the second gear wheel at a side of the first wheel that faces the second gear wheel, and vice versa. In other words, the gear wheel assembly is preferably such that the respective gear wheels are directly supported by each other on the side of the respective gear wheels that face each other. A separate collective axle, or separate individual axles, for radially supporting the gear wheels is thereby not needed. Preferably, only the side of respective gear wheel facing the other gear wheel is (at least) radially supported by the other gear wheel, and vice versa. It is then possible the other side that faces away from the other gear wheel is directly supported, preferably through an external support bearing, on a housing member and/or frame member of, preferably, the transmission system.

In gear wheel assemblies according to the prior art, each gear wheel is typically supported on either side of the gear wheel, through respective bearings arranged on both sides, on a housing member and/or frame member. In such a traditional gear wheel assembly, in particular a traditional dual gear wheel assembly, a total of two gear wheels and four bearings would be adjacently arranged, as seen along the first axis, such that at least two adjacently arranged support bearings for supporting the gear wheels onto the housing member and/or frame member would be arranged in between the gear wheels. In the gear wheel assembly according to the present patent disclosure, the gear wheels are supported directly by each other, on the respective sides that face each other, such that a more compact arrangement, as seen along the first axis, can be obtained. Hereby, the installation-space required for the gear wheel assembly is reduced, whereby the size of the transmission system is reduced (i.e. a more compact transmission system is obtained).

A parallel axis gear system, which differs from a planetary gear system, comprises at least a single gear stage comprising a pinion and gear wheel that engage, wherein the pinion and gear wheel rotate around respective own axes that are spaced apart and substantially parallel to each other. In addition, the respective axes are arranged stationary with respect to each other.

In a preferred embodiment, the intermediate bearing arrangement is arranged, preferably completely, in between the first and second gear wheels, such that said intermediate bearing arrangement is connected only to the first and second gear wheel. Hereby, the gear wheels can be spaced closer together (as seen along the first axis), such that the more compact gear wheel assembly is obtained, as is described above.

It is preferred that the first intermediate bearing comprises a ball bearing and/or roller bearing, as these are relatively compact and suitable for running at different rotational speeds, which is related to the driving speed of a vehicle, while also providing sufficient stiffness to cope with a varying torque that the motor delivers. This thus enables to provide for a compact transmission system as is described above.

It is then preferred that the ball bearing and/or roller bearing comprises a first raceway and second raceway where between a plurality of balls or rollers of the respective bearing are arranged; and
wherein the first raceway is connected to the first gear wheel and the second raceway is connected to the second gear wheel. Such a construction enables that the respective gear wheels are directly supported by each other on the side of the respective gear wheels that face each other, wherein the bearing is provided in a space in between the respective gear wheels. This leads, in at least the direction as seen along the first axis, to a compact arrangement of the gear wheel assembly and as is described above.

In a preferred embodiment said first gear wheel comprises a coaxial cylindrical protrusion extending in the direction of the second gear wheel, wherein the first intermediate bearing is arranged on the coaxial cylindrical protrusion; and wherein said second gear wheel comprises a coaxial cylindrical recess arranged for receiving and holding said coaxial cylindrical protrusion and said first intermediate bearing. In such an arrangement, the bearing can be placed between the coaxial cylindrical protrusion and the coaxial cylindrical recess, such that the compact arrangement is obtained.

In a preferred embodiment, said first intermediate bearing is at least a radial bearing for transferring forces that are perpendicular to the first axis between the respective first and second gear wheels; wherein said radial bearing is preferably a radial needle roller bearing. The needle bearing is a special type of roller bearing which uses long, thin cylindrical rollers resembling needles. Needle bearings have a large surface area that in contact with the races, so they can support a large radial load and have a relatively high radial stiffness. In addition, as they are relatively thin, they require a relatively small clearance (as seen in the radial direction) between the gear wheels, such that a compact and radially stiff arrangement of the gear wheel assembly is obtained.

It is preferred that said first gear wheel is axially supported through the intermediate bearing arrangement by said second gear wheel and wherein said second gear wheel is axially supported through the intermediate bearing arrangement by said first gear wheel. As the gear wheels are often helical gear wheels, i.e. a type of cylindrical gear with a slanted tooth trace, the force acting on a slanted tooth of the gear wheel comprise a transverse component that is parallel to the first axis. It is noted however, that the disclosure is not limited to helical gear wheels, but can, for instance, also comprise gear wheels with straight teeth. This transverse component thus introduces an axial force, but also a bending (i.e. tilting) moment, that is preferably to be accommodated by the intermediate bearing arrangement. As the intermediate bearing arrangement is arranged for axially supporting one of the gear wheels on the other of the gear wheels, and vice versa, the axial load can be accommodated by the gear wheel assembly. Also in case of straight teeth, significant radial forces are introduced as only the teeth of the single input pinion interact with the teeth of the gear wheel, such that these forces are not balancing as would be the case for, for instance, a sun wheel of a planetary gear system, wherein three, four, or more planetary gears surrounding the sun wheel introduce radial forces of similar magnitude, thereby resulting in a force balance on the sun wheel. The resulting radial force that is induced on the respective gear wheel thereby leads, due to arm (i.e. distance) between the intermediate bearing arrangement and the location on the gear wheel where the force is applied, to a tilting moment that acts on the gear wheel and that needs to be counteracted by the intermediate bearing arrangement.

Hereby it is noted that the gear assembly according to the current patent disclosure can also comprise the axial support between the respective gear wheel, as is further disclosed below, without comprising the radial support between the respective gear wheels that was discussed thus far. Alternatively, the gear assembly according to the current patent disclosure can only comprise the axial support between the respective gear wheels, without the radial support and/or only comprise the radial support between the respective gear wheels, without the axial support.

It is then preferred that the intermediate bearing arrangement comprises a second intermediate bearing, separate from the first intermediate bearing, that is arranged for transferring forces that are parallel to the first axis. This allows for applying a dedicated axial and a dedicated radial bearing, which can be optimized in terms of compactness, performance and required stiffness, instead of having to combine both possibilities in a single bearing such that a trade-off is required in these regards. It is noted that the dedicated axial and dedicated radial bearings could, in an embodiment, also be two distinct bearings, of which at least one (or even both) combines both functionalities, such that the at least one is able to act as a radial and axial bearing.

In case a second intermediate bearing is applied, it is preferred that each of said first and second gear wheel comprises a radial wall extending radially outwards, with respect to the first axis, towards an outer circumferential wall that comprises teeth, wherein the radial wall of each of said first and second gear wheel comprises an inner side that faces the inner side of the other of said first and second gear wheel;
wherein said second intermediate bearing is an axial bearing, preferably an axial needle roller bearing; and
wherein said second intermediate bearing is arranged coaxially with the first axis in between the respective inner sides of the gear wheel.

A gear wheel assembly can thereby be obtained that is both compact, as the second intermediate bearing is also arranged in between the respective gear wheels, and stiff in the axial direction. This is particularly of interest in case the gear wheels are helical gear wheels, as in this case the transverse component of the force also gives a bending moment on the gear wheel that acts essentially parallel to the first axis. Or in other words, the point at which the gear wheel interacts with an input pinion will be urged to bend sideways (i.e. in a direction parallel to the first axis). By arranging the bearing between the respective radial wall of the gear wheels, a relatively stiff support is obtained that will be able to counteract the induced bending. Especially, in combination with an axial needle roller bearing, this is capable of taking large loads, is stiff and compact, a compact and axially stiff arrangement of the gear wheel assembly is obtained.

Preferably, the first and/or second gear wheel has a radius; and wherein the second intermediate bearing is arranged at, i.e. extends radially outwardly to, a distance from the first axis, wherein said distance is at least 20% of the radius, preferably at least 40% of the radius, more preferably at least 60% of the radius. By arranging the second intermediate bearing as much as possible in the radially outward direction, the tilting moment acting on the gear wheel (as is described above) is counteracted in an improved manner by the intermediate bearing arrangement and an (axially and bending-wise) as stiff as possible gear wheel assembly can be obtained that is still compact, as is described above.

In a preferred embodiment, said gear wheel assembly comprises an outer bearing arrangement, wherein said outer bearing arrangement is arranged for axially and radially supporting said first and second gear wheels on a housing and/or frame member, such that said first and second gear wheels are arranged to rotate around said first axis with respect to said housing member and/or frame member. By arranging the gear wheels with the outer bearing arrangement as described, the compact set of gear wheels can be arranged within a compact housing member and/or frame member. Preferably, said outer bearing arrangement is directly connected to an outer (i.e. overall) housing of the transmission system, such that the bearing arrangement is fixed, i.e. stationary, with respect to the outer housing of the transmission system.

Herein it preferred that each of said first and second gear wheel comprises a radial wall extending radially outwards, with respect to the first axis, towards an outer circumferential wall that comprises teeth, wherein the radial wall of each of said first and second gear wheel comprises an inner side that faces the inner side of the other of said first and second gear wheel and an outer side that is opposite to the inner side; wherein said outer bearing arrangement comprise a first outer bearing and a second outer bearing, wherein said first outer bearing is connected to the first gear wheel at the outer side of the first gear wheel and wherein the second outer bearing is connected to the second gear wheel at an outer side of the second gear wheel. The gear wheels are thereby arranged in between the first and second outer bearing, as seen along the first axis, such that a compact setup is obtained that is reliably supported by the housing member and/or frame member.

Preferably, said outer bearing arrangement is arranged with an axial compression pre-load, such that said first gear wheel is urged to said second gear wheel and vice versa. Especially in combination with the second, i.e. axial, intermediate bearing, it is possible to obtain a stiff and compact gear wheel assembly, as the compression pre-load ensures that second intermediate bearing remains under compression, such that is function reliably. This enable the use of a compact and stiff, but simple, axial roller needle bearing that functions best under an axial compression pre-load, thereby enabling to obtain the compact and reliable gear wheel assembly. The reaction forces due to the pre-load are, in case the outer bearing arrangement is directly connected to the outer housing, directly transferred to the outer housing, such that the stiff arrangement is obtained.

In a preferred embodiment, said outer bearing arrangement comprises tapered roller bearings, ball bearings and/or angular ball bearings, wherein, preferably, said axial compression pre-load is arranged by mounting said tapered roller bearings, ball bearings and/or angular ball bearings with an axial compression pre-load on the respective gear wheels. As tapered roller bearings, ball bearings and/or angular ball bearings are able to take up both radial and axial forces, a single bearing can be applied per side of the gear wheel assembly for connecting the gear wheel assembly to a housing member and/or frame member. In addition, these bearings can be mounted, in for instance the housing member and/or frame member, in such a manner as to provide for a axial compression pre-load, as is described above.

Preferably, said first gear wheel is arranged with a hollow cylindrical hub that extends outwardly, with respect to the inner and outer side of the first gear wheel, in both axial directions and wherein said second gear wheel is arranged with a hollow cylindrical hub that extends, preferably only, outwardly with respect to the outer side of the second gear wheel, and wherein each hub is arranged for receiving a respective drive shaft and, preferably, comprises a splined connection section thereto. A drive-shaft can then efficiently be connected to the gear wheel through the splined connection of the central hub.

Such an arrangement with outwardly extending hollow cylindrical hubs allows for mounting any bearings around the hollow cylindrical hub, such that a compact arrangement can be obtained. Furthermore, as is described below, an intermediate bearing can thereby also be arranged on the outside circumference of a part of the hollow cylindrical hub that extends outwardly with respect to the inner side, i.e. the side that faces the second gear wheel, of the of the first gear wheel. Thereby, this part acts essentially as a rotating axle around which the second gear wheel can be mounted and is supported by. Preferably, the coaxial cylindrical protrusion, as described in an embodiment given above, is arranged on a radial outer surface of the hollow cylindrical hub of the first gear wheel. Hereby, the function of the hub is integrated with the arrangement of the intermediate bearing, such that the compact gear wheel assembly can be obtained.

In a second aspect, the present patent disclosure provides for a transmission system for a dual drive vehicle drive train comprising a gear wheel assembly according to the present patent disclosure and a respective first and second intermediate shaft, each comprising an input gear wheel for receiving a torque from a respective first or second motor and an output pinion that meshes with the respective first and second gear wheel, preferably wherein each of the respective axes of the first and second intermediate shafts are stationary. The more gear wheel assembly according to the present disclosure allows to thereby also obtain a more compact transmission system comprising the gear wheel assembly. The transmission system according to the invention is thereby arranged such that the first gear wheel can only be driven by the first intermediate shaft and the second gear wheel can only be driven by the second intermediate shaft. Preferably, the first intermediate shaft is arranged to be driven by, preferably only, the first motor and the second intermediate shaft is arranged to be driven by, preferably only, the second motor, such that the first and second gear wheel cannot be driven by the same motor. Preferably, the first gear wheel is arranged for driving a first drive shaft, that is arranged for driving a first driven wheel and said second gear wheel is arranged for driving a second drive shaft that is arranged for driving a second driven wheel. This allows to obtain a dual drive vehicle drive train wherein the first driven wheel can, preferably only, be driven by the first motor and the second driven wheel can, preferably only, be driving by the second motor. As such, the first and second driven wheel cannot be driven by the same motor.

In a preferred embodiment of the transmission system, the respective axes of the first and second intermediate shaft are arranged parallel to the first axis and wherein, as seen in a plane perpendicular to the first axis, a virtual line, comprising of two line sections, running from the axis of the first intermediate shaft to the first axis (for the first line section) and subsequently to the axis of the second intermediate shaft (for the second line section) comprises an angle of 180 degrees or less than 180 degrees, preferably less than 120 degrees (between the respective line sections of the virtual line). A more balanced load distribution in the transmission system is obtained for a small angle. The smaller the angle between the two shafts, the smaller the resulting force. If counteracting forces align, there will be no resulting tipping force. On the other hand, an angle of, or less than, 180 degrees, preferably less than 120 degrees, allows obtaining a more compact setup of a drive train, that, preferably, includes two, preferably substantially the same, motors connected to the transmissions system.

In a third aspect, the present patent disclosure provides for a dual drive vehicle drive train comprising a transmission system according to the present disclosure and comprising a first and second motor, wherein said motors are preferably substantially identical to each other, in particular electric motors, that are, preferably directly, operatively coupled to the respective first and second intermediate shaft. Hereby a compact dual drive vehicle drive train is obtained wherein the first driven wheel can, preferably only, be driven by the first motor and the second driven wheel can, preferably only, be driven by the second motor. As such, the first and second driven wheel cannot be driven by the same motor.

In a fourth aspect, the present patent disclosure provides for a vehicle comprising at least one dual drive vehicle drive train according to the present disclosure, wherein said dual drive vehicle drive train is arranged in a front axle, or a rear axle, or wherein a respective dual drive vehicle drive train is arranged in both the front and rear axle;
wherein the respective front and/or rear axle comprise two (driven) vehicle wheels; and
wherein said first gear wheel is operatively coupled, through a respective first drive shaft, to a first (driven) vehicle wheel of the respective front or rear axle, and wherein said second gear wheel is operatively coupled, through a respective second drive shaft, to a second (driven) vehicle wheel of the respective front or rear axle. Hence, the first driven wheel can, preferably only, be driven by the first motor and the second driven wheel can, preferably only, be driving by the second motor. Or in other words, the first and second driven wheel cannot be driven by the same motor.

Hereby, a more effective use of the space of the vehicle is obtained. Secondly, vehicle designers are given a larger design freedom, as the drive train is a more compact system that requires only limited space to be integrated into the vehicle, such as a truck, utility van, or passenger car.

The above and other advantages of the features and objects of the disclosure will become more apparent and the aspects and embodiments will be better understood from the following detailed description when read in conjunction with the accompanying drawings, which show preferred embodiments of the shaft assemblies and systems according to the present patent disclosure, and are not intended to limit the scope of the invention in any way, wherein:

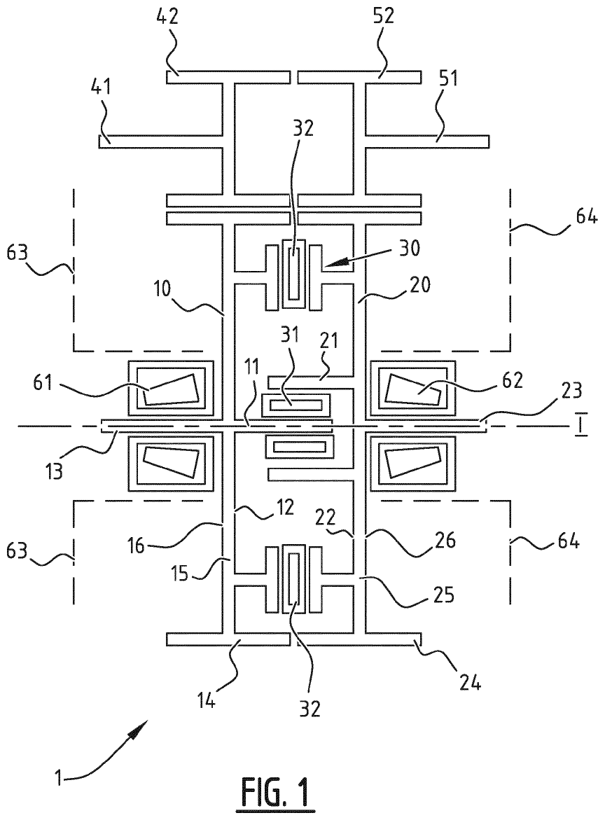

FIG. 1 is a schematic representation of a part of a transmission system comprising an embodiment of the gear wheel assembly according to the present disclosure.

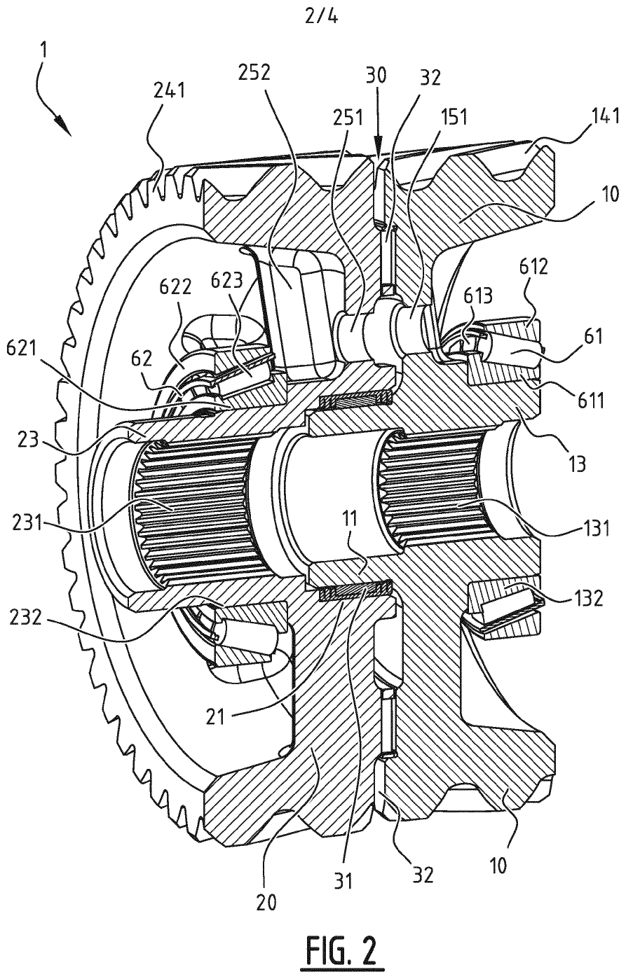

FIG. 2 is a three dimensional perspective view of an embodiment of the gear wheel assembly.

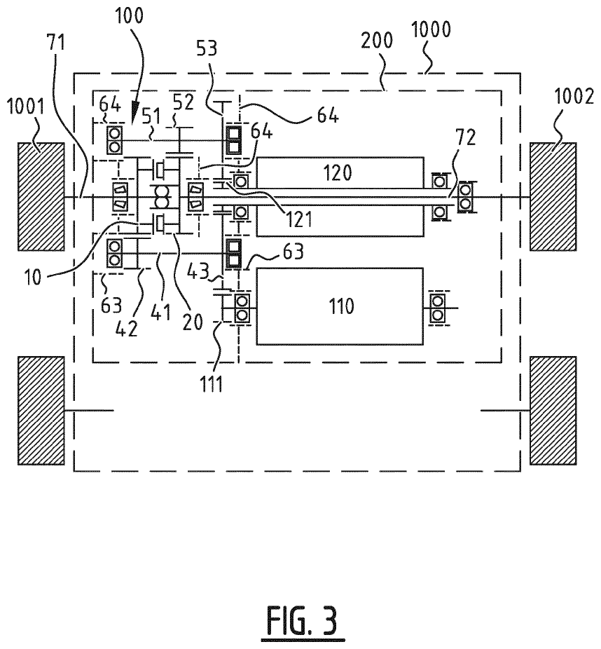

FIG. 3 is schematic representation of a vehicle comprising a dual drive vehicle drive train comprising an embodiment of transmission system according to the present disclosure.

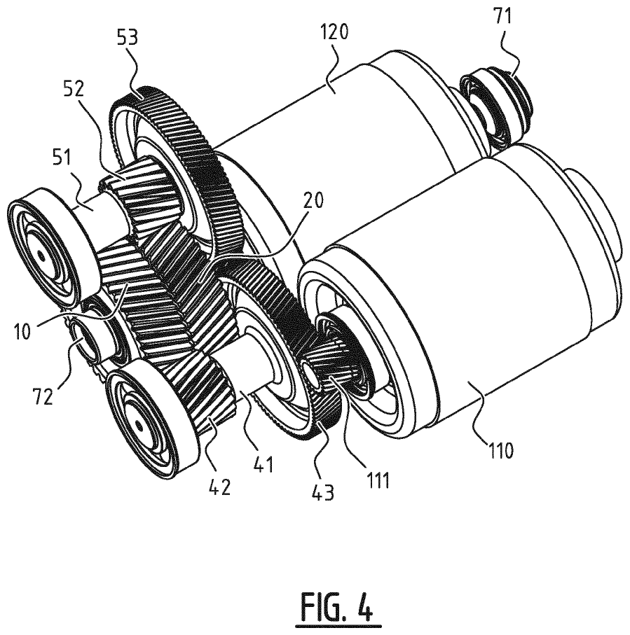

FIG. 4 is three dimensional perspective of a part of an embodiment of the transmission system according to the present disclosure.

FIGS. 1 and 2 show a final stage gear wheel assembly 1 for a, preferably parallel axes, transmission system 100 for a dual drive vehicle drive train 1000. The gear wheel assembly 1 comprises a first gear wheel 10 and a second gear wheel 20, wherein the first and second gear wheels 10, 20 are arranged coaxially with respect to a first axis I. The first gear wheel 10 is arranged adjacent to the second gear wheel 20 and is coupled to the second gear wheel 20 through an intermediate bearing arrangement 30 that allows for relative rotation of the first gear wheel 10 with respect to the second gear wheel 20 around the first axis I. In the current embodiment, the intermediate bearing arrangement 30 comprises a first intermediate bearing 31, in particular a radial roller needle bearing 31. The first gear wheel 10 is thereby radially supported through the first intermediate bearing 31 by the second gear wheel 20 and vice versa.

The gear wheels 10, 20 of the embodiment are formed by respective coaxial central hubs 13, 23 that are arranged for connecting to respective drive shafts 71, 72, for instance by means of splined connection interfaces 131, 231, respective outer circumferential walls 14, 24 whereon teeth 141, 241 are arranged and respective radial walls 15, 25 extending radially outwards to the respective outer circumferential walls 14, 24 with respect to the respective coaxial central hubs 13, 23. It is noted that the radial walls 15, 25 need not be continuous walls, but may comprise openings 151, 251 and/or stiffeners 252 and may even not be shaped as a wall at all, but rather be a series of spokes or any type of structure that connects the coaxial central hubs 13, 23 with the outer circumferential walls 14, 24. The respective sides of the radial walls 15, 25 that face each other are considered the inner sides 12, 22, whereas the respective sides of the radial walls 15, 25 that face away from each other are considered the outer sides 16, 26.

The radial roller needle bearing 31 is arranged in between a coaxial cylindrical protrusion 11, or axle protrusion 11, that extends, coaxially with the first axis I, outwardly with respect to the inner side 12 of the first gear wheel 10 in the direction of the second gear wheel 20 and a coaxial cylindrical recess 21 that is arranged on, or in, the inner side 22 of the second gear wheel 20 for receiving the radial roller needle bearing 31 and the coaxial cylindrical protrusion 11. In the present embodiment, the first intermediate bearing 31, in particular the radial roller needle bearing 31, is thus arranged completely in between, and is only connected to, the first and second gear wheels 10, 20.

In the present embodiment, the intermediate bearing arrangement 30 comprises a second intermediate bearing 32, in particular an axial needle roller bearing 32, separate from the first intermediate bearing 31, that is arranged for transferring axial forces between the respective gear wheels 10, 20 that are parallel to the first axis I. The axial needle roller bearing 32 is arranged coaxially with the first axis, as seen from the first axis I, and extends radially outwardly on the respective inner sides 12, 22 of the first and second gear wheels 10, 20. The second intermediate bearing 32 extends radially outwardly to a distance from the first axis, wherein said distance is at least 20% of the radius, preferably at least 40% of the radius, more preferably at least 60% of the radius. The further the axial bearing extends outwardly, the stiffer the gear wheel assembly is in axial direction. The second intermediate bearing 32, in particular the axial roller needle bearing 32, is thus arranged completely in between, and is only connected to, the first and second gear wheels 10, 20.

The gear wheel assembly 1 comprises an outer bearing arrangement that is arranged for axially and radially supporting the first and second gear wheels 10, 20 on a housing and/or frame member 63, 64, such that said first and second gear wheels 10, 20 are arranged to rotate around said first axis I with respect to said housing and/or frame member 63, 64.

The outer bearing arrangement comprises a first outer bearing 61 and a second outer bearing 62, wherein the first outer bearing 61 is connected to the first gear wheel 10 at the outer side 16 of the first gear wheel 10 and wherein the second outer bearing 62 is connected to the second gear wheel 20 at an outer side 26 of the second gear wheel 20. In particular, the bearings 61, 62 are arranged around the respective coaxial hubs 13, 23 of the first and second gear wheels 10, 20. Hence, respective inner raceways 611, 621 of the respective bearings 61, 62 are connected to the outer radial walls 132, 232 of the respective coaxial hubs 13, 23 and the respective outer raceways 612, 622 are connected to the respective frame member and/or housing member 63, 64. Tapered rollers 613, 623 are arranged in between the respective inner and outer raceways 611, 621, 612, 622. Alternatively, ball bearings and/or angular ball bearings may be provided.

The bearings 61, 62 are mounted onto the frame member and/or housing member 63, 64 with an axial compression pre-load, such that the axial roller needle bearing 32 is pre-loaded with an axial compression pre-load. Axial and radial roller needle bearing are constructed similarly to the tapered roller bearings, such that the roller needles are arranged in between an inner and outer raceway.

FIG. 3 schematically shows a vehicle 1000 comprising the dual drive vehicle drive train 200, that comprises the, preferably parallel axes, transmission system 100. The final stage gear wheels 10, 20 of the transmission system 100 are, as is best seen in FIGS. 3 and 4, driven by the respective intermediate shaft output pinons 42, 52 of the respective intermediate shafts 41, 51. The respective intermediate shafts 41, 51 are driven by, preferably only, the respective the motor output pinions 111, 121 through the respective intermediate shaft gear wheels 43, 53. The respective motors 110, 120, that are preferably substantially equally sized and/or substantially the same motors, thereby drive, through their respective output pinions 111, 121 and the transmission system 100 the respective drive shafts 71, 72 that are connected to the respective wheels 1001, 1002 of the vehicle, such that, the first driven wheel can, preferably only, be driven by the first motor and the second driven wheel can, preferably only, be driving by the second motor. Or in other words, the first and second driven wheel cannot be driven by the same motor.

FIG. 4 shows that the respective axes of the first and second intermediate shaft 41, 51 are arranged parallel to the first axis I and wherein, as seen in a plane perpendicular to the first axis I, a virtual line running from the axis of the first intermediate shaft 41 to the first axis and subsequently to the axis of the second intermediate shaft 52 comprises an angle of less than 180 degrees, in particular less than 120 degrees.

The description of the different illustrative configurations has been presented for purposes of illustration and description and is not intended to be exhaustive or limited to the configurations in the form disclosed. Many modifications and variations will be apparent to those of skill in the art. Further, different illustrative configurations may provide different features as compared to other illustrative configurations. The configuration or configurations selected are chosen and described in order to best explain the principles of the configurations, the practical application, and to enable others of ordinary skill in the art to understand the disclosure for various configurations with various modifications as are suited to the particular use contemplated.

1. A gear wheel assembly for a transmission system for a dual drive vehicle drive train, the gear wheel assembly comprising:
a first gear wheel and a second gear wheel, wherein said first and second gear wheel are arranged coaxially with respect to a first axis, wherein said first gear wheel is arranged adjacent to said second gear wheel and is coupled to said second gear wheel through an intermediate bearing arrangement that allows for relative rotation of the first gear wheel with respect to the second gear wheel around said first axis;
wherein the intermediate bearing arrangement comprises a first intermediate bearing; and
wherein said first gear wheel is radially supported through the first intermediate bearing by said second gear wheel and wherein said second gear wheel is radially supported through the first intermediate bearing by said first gear wheel.

2. The gear wheel assembly according to claim 1, wherein the intermediate bearing arrangement is arranged in between the first and second gear wheels, such that said intermediate bearing arrangement is connected only to the first and second gear wheel.

3. The gear wheel assembly according to claim 1, wherein the first intermediate bearing comprises a ball bearing and/or roller bearing.

4. The gear wheel assembly according to claim 3, wherein the ball bearing and/or roller bearing comprises a first raceway and second raceway where between a plurality of balls or rollers of the respective bearing are arranged; and
wherein the first raceway is connected to the first gear wheel and the second raceway is connected to the second gear wheel.

5. The gear wheel assembly according to claim 1, wherein said first gear wheel comprises a coaxial cylindrical protrusion extending in the direction of the second gear wheel, wherein the first intermediate bearing is arranged on the coaxial cylindrical protrusion; and wherein said second gear wheel comprises a coaxial cylindrical recess arranged for receiving and holding said coaxial cylindrical protrusion and said first intermediate bearing.

6. The gear wheel assembly according to claim 1, wherein said first intermediate bearing is at least a radial bearing for transferring forces that are perpendicular to the first axis between the respective first and second gear wheels.

7. The gear wheel assembly according to claim 1, wherein said first gear wheel is axially supported through the intermediate bearing arrangement by said second gear wheel and wherein said second gear wheel is axially supported through the intermediate bearing arrangement by said first gear wheel.

8. The gear wheel assembly according to claim 7, wherein the intermediate bearing arrangement comprises a second intermediate bearing, separate from the first intermediate bearing, that is arranged for transferring forces that are parallel to the first axis.

9. The gear wheel assembly according to claim 8, wherein each of said first and second gear wheel comprises a radial wall extending radially outwards, with respect to the first axis, towards an outer circumferential wall that comprises teeth, wherein the radial wall of each of said first and second gear wheel comprises an inner side that faces the inner side of the other of said first and second gear wheel;
wherein said second intermediate bearing is an axial bearing; and
wherein said second intermediate bearing is arranged coaxially with the first axis in between the respective inner sides of the gear wheel.

10. The gear wheel assembly according to claim 8, wherein said first and/or second gear wheel has a radius; and
wherein the second intermediate bearing extends radially outwardly to a distance from the first axis, wherein said distance is at least 20% of the radius.

11. The gear wheel assembly according to claim 1, wherein said gear wheel assembly comprises an outer bearing arrangement, wherein said outer bearing arrangement is arranged for axially and radially supporting said first and second gear wheels on a housing and/or frame member, such that said first and second gear wheels are arranged to rotate around said first axis with respect to said housing and/or frame member.

12. The gear wheel assembly according to claim 11, wherein each of said first and second gear wheel comprises a radial wall extending radially outwards, with respect to the first axis, towards an outer circumferential wall that comprises teeth, wherein the radial wall of each of said first and second gear wheel comprises an inner side that faces the inner side of the other of said first and second gear wheel and an outer side that is opposite to the inner side; and
wherein said outer bearing arrangement comprise a first outer bearing and a second outer bearing, wherein said first outer bearing is connected to the first gear wheel at the outer side of the first gear wheel and wherein the second outer bearing is connected to the second gear wheel at an outer side of the second gear wheel.

13. The gear wheel assembly according to claim 11, wherein said outer bearing arrangement is arranged with an axial compression pre-load, such that said first gear wheel is urged to said second gear wheel and vice versa.

14. The gear wheel assembly according to claim 11, wherein said outer bearing arrangement comprises tapered roller bearings, ball bearings and/or angular ball bearings.

15. The gear wheel assembly according to claim 1, wherein said first gear wheel is arranged with a hollow cylindrical hub that extends outwardly, with respect to the inner and outer side of the first gear wheel, in both axial directions and wherein said second gear wheel is arranged with a hollow cylindrical hub that extends outwardly with respect to the outer side of the second gear wheel, and wherein each hub is arranged for receiving a respective drive shaft.

16. The gear wheel assembly according to claim 5, wherein said first gear wheel is arranged with a hollow cylindrical hub that extends outwardly, with respect to the inner and outer side of the first gear wheel, in both axial directions and wherein said second gear wheel is arranged with a hollow cylindrical hub that extends outwardly with respect to the outer side of the second gear wheel, and wherein each hub is arranged for receiving a respective drive shaft; and
wherein said coaxial cylindrical protrusion is arranged on a radial outer surface of the hollow cylindrical hub of the first gear wheel.

17. A transmission system for a dual drive vehicle drive train comprising the gear wheel assembly according to claim 1 and a respective first and second intermediate shaft, each comprising an input gear wheel for receiving a torque from a respective first or second motor and an output pinion that meshes with the respective first and second gear wheel.

18. The transmission system according to claim 17, wherein the respective axes of the first and second intermediate shaft are arranged parallel to the first axis and wherein, as seen in a plane perpendicular to the first axis, a virtual line running from the axis of the first intermediate shaft to the first axis to the axis of the second intermediate shaft comprises an angle of 180 degrees or less than 180 degrees.

19. A dual drive vehicle drive train comprising the transmission system according to claim 17 and further comprising a first motor and a second motor that are operatively coupled to the respective first and second intermediate shaft.

20. A vehicle comprising at least one dual drive vehicle drive train according to claim 19, wherein said dual drive vehicle drive train is arranged in a front axle, or a rear axle, or wherein a respective dual drive vehicle drive train is arranged in both the front and rear axle;
wherein the respective front and/or rear axle comprise two vehicle wheels; and
wherein said first gear wheel is operatively coupled, through a respective first drive shaft, to a first vehicle wheel of the respective front or rear axle, and wherein said second gear wheel is operatively coupled, through a respective second drive shaft, to a second vehicle wheel of the respective front or rear axle.
